(19) United States
(12) Patent Application Publication
(10) Pub. No.: US 2026/0127157 A1
(43) Pub. Date: May 7, 2026

(54) STAND-IN MODEL FOR DOMAIN LEVEL SERVICES

(71) Applicant: PAYPAL, INC., San Jose, CA (US)

(72) Inventors: Prabin Patodia, Kolkata (IN); Rajendra Bhat, Bangalore Urban (IN)

(21) Appl. No.: 18/934,944

(22) Filed: Nov. 1, 2024

(51) Int. Cl. G06F 16/23; G06F 16/22

(52) U.S. Cl. CPC G06F 16/23; G06F 16/2272

(57) ABSTRACT

System and methods for providing stand-in services at a domain can include obtaining a service request at a domain, determining one or more services at the domain to fulfill the service request, in response to determining a service of the one or more services is unavailable, providing a model as a stand-in service for the service, determining, by the one or more services and the model, a decision based on the service request, and sending, in response to the service request, the decision as output by the domain level. The model can provide the stand-in service by obtaining data for the service based on the service request context, identifying one or more keys based on the obtained context data, retrieving, based on the one or more keys, data from a cache, and applying the data to the model, the decision being based on the data applied to the model.

### FIELD

The present disclosure relates to the field of data architecture. More particularly, to a stand-in model for domain level services in data architecture.

### BACKGROUND

An electronic service request received by a system or network of an entity from a user computing device can be fulfilled by leveraging one or more domains of the system data architecture to make respective determinations of whether to fulfill the user's service request. Each domain includes a number of micro-services, and the system can utilize a subset of these micro-services at a given domain to fulfill the service request, or a respective portion thereof, according to the models, policies, rules, and standards of the entity. In fulfilling the service request, the service request data can be provided as input to the subset of micro-services of the domain, and the subset of micro-services can interact with each other and output a determination based on the data in fulfillment of the service request to the domain.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a block diagram of an example system for providing stand-in service functionality at a domain, according to some embodiments.

FIG. 2 is a flow chart illustrating an example method of providing the stand-in service functionality.

FIG. 3 is a block diagram view of an example system for performing the method of FIG. 2.

FIG. 4 is a block diagram view of an example domain level in system for performing the method of FIG. 2.

FIG. 5 is a flow diagram of an example method for processing data at a domain level, according to some embodiments.

FIG. 6 is a flow diagram of an example method for processing data at a domain level, according to some embodiments.

FIG. 7 is a flow diagram of an example method for processing the data at a domain level, according to some embodiments.

FIG. 8 is a flow diagram of an example method for providing the stand-in service, according to some embodiments.

FIG. 9 is a block diagram of an example domain level of system, according to some embodiments.

FIG. 10 is a block diagram of an example computing system, according to some embodiments.

### DETAILED DESCRIPTION

A system can implement a data architecture that includes a number of domains that perform different processing tasks such as, for example, fulfillment evaluation, risk compliance, IP address validation, electronic transaction fulfillment, etc. Each domain can include one or more micro-services, and the system can leverage the micro-services at each domain to perform the respective processing task. For example, the one or more micro-services at a particular domain can be utilized to validate a user authentication based on data input to the one or more micro-services at the domain.

To utilize a domain, the system can generate a service request and send the service request to a corresponding domain. The service request can include, for example, request data including parameters of the request, user profile data, account data, personal data, device data, behavioral data, and the like. For example, the service request can include data in context of a transaction. In another example, the service request can include credit history data of a user. In some embodiments, the system can generate one or more service requests, and each service request can be allocated to a respective domain of the one or more domains of the system. For example, the system can generate multiple service requests for multiple domains of the system in response to a single transaction request from a user.

The system can determine which of the one or more domains and corresponding micro-services to utilize to fulfill a request. In some embodiments, the domain can include a plurality of micro-services, and the domain can determine a subset of the micro-services to utilize to fulfill the request. In some embodiments, the domain can determine which micro-services to utilize to fulfill the service request based on a context of the service request. In this regard, the domain can obtain data corresponding to the service request and can apply the data, or one or more portions thereof, to one or more of the micro-services of the domain to fulfill the service request. For example, a domain for performing risk evaluations of electronic transactions can include 100 distinct micro-services, and the domain can utilize 80 of these micro-services to fulfill a service request for determining a risk level associated with fulfilling an electronic transaction. In some embodiments, the domain can determine which micro-services to utilize to fulfill the service request based on the context of the data corresponding to the service request. In other embodiments, the service request can include data indicating which micro-service(s) to utilize to fulfill the request.

A domain can include one or more micro-services. Each micro-service can be utilized by the domain to perform one or more processing operations to fulfill a service request. Each micro-service at the domain can perform a respective processing task independent of the other micro-services, can perform a processing task in parallel with one or more other micro-services, or any combination thereof.

The one or more micro-services of the domain can perform one or more processing tasks and provide an output corresponding to a determination based on the service request. For example, the one or more micro-services can output a determination corresponding to a prediction that an electronic transaction being performed at the system is fraudulent based on a credit card that is utilized for the electronic transaction may be stolen, and the system can reject the electronic transaction based on the determination. In another example, the system can reject an electronic transaction request from a user based on a domain and corresponding micro-service(s) determining that the IP address of the computing device submitting the electronic transaction request does not match the IP address stored in the user's account.

Domains can generally only utilize the available micro-services to fulfill a service request. Failure of a micro-service the domain may need to utilize to fulfill the service request can result in, for example, a timing out of the service request or an inability of the domain to output an accurate determination in response to the service request. This can lead to the domain providing a false positive or false negative determination, which can negatively impact electronic transaction processing fulfillment by the system. In an example, a false positive determination of a user authentication can result in the system fulfilling a fraudulent electronic transaction, thereby resulting in a financial loss to the entity. In another example, a false negative determination can result in a user account not being able to complete electronic transactions with other users of the system and result in a bad user experience, among other negative effects.

Various embodiments of the present disclosure relate to systems and methods for providing a machine learning model that can be utilized to provide stand-in service functionality to domains. The machine learning model can be configured so as to serve as a stand-in service for any one of the micro-services of the domain when fulfilling a service request. In some embodiments, the machine learning model can be configured to serve as a stand-in for one or more micro-services of the domain.

When a micro-service that is needed by the domain to fulfill a service request becomes unavailable, the domain can utilize the machine learning model to serve as a stand-in service for the unavailable micro-service. In this regard, the machine learning model can be configured to serve as a stand-in for the micro-service by performing operations including, for example, obtaining a context data, identifying the unavailable micro-service, identifying the application programming interface (API), identifying a key or set of keys based on the context data, and retrieving data from a cache using the key or set of keys. In addition, as the stand-in service for the micro-service, the machine learning model can be configured to perform operations including, for example, executing a processing task of the micro-service and providing an output to the domain based on the processing.

The stand-in service functionality provided by the machine learning model of the present disclosure improves the availability of the domains in the system by improving the availability of the corresponding micro-services of the domains. The stand-in service functionality provided by the machine learning model of the present disclosure also improves efficiency by reducing time-outs due to domains failing to fulfill a service request due to unavailable micro-services. The stand-in service functionality provided by the machine learning model of the present disclosure also improves the accuracy of determinations made at a domain that may otherwise result if one or more micro-services of the domain were unavailable.

The stand-in service functionality provided by the machine learning model of the present disclosure provides improvements over other data architectures that utilizes individual stand-in services at a domain. In these other data architectures, individual stand-in services are generally rule-driven and operate based on a relatively small set of rules. Moreover, individual stand-in services are typically provided for certain micro-services (e.g., critical micro-services or commonly utilized micro-services) because a domain can include tens, hundreds, or more individual micro-services and because of the challenges associated with creating individual stand-in services for each of the domain's micro-services. That is, it can be time and labor intensive and costly to develop, deploy, maintain, and perform upgrades on individual stand-in services for hundreds, thousands, or more micro-services that each perform a different processing task. In this regard, the various embodiments of the present disclosure improve upon the individual stand-in services implemented in other data architectures by providing a machine learning model that can provide a stand-in service that can be configured to serve as a replacement for any (or all) of the micro-services in the domain based on a service request and a context of the service request.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

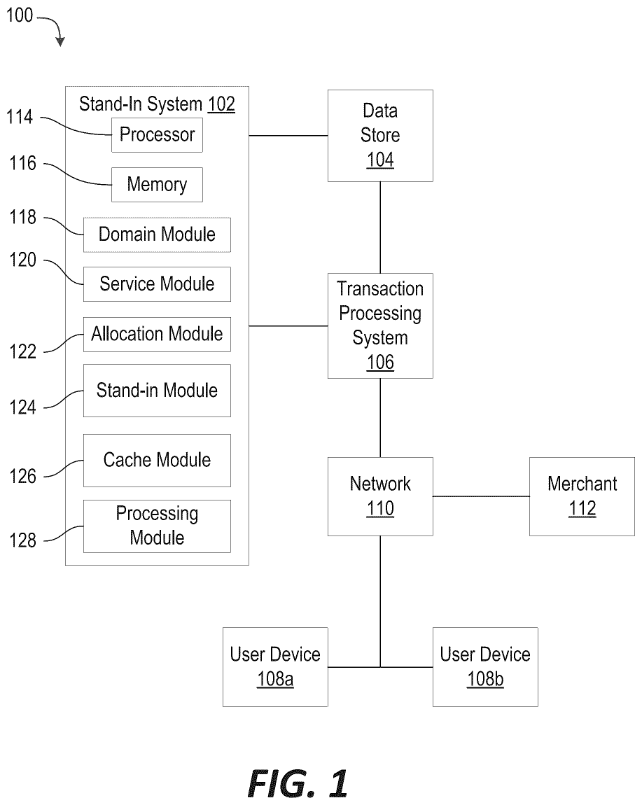

FIG. 1 is a block diagram of an example system 100 for providing stand-in service functionality at a domain, according to some embodiments.

System 100 can include a stand-in system 102, a data store 104, a transaction processing system 106, a plurality of user devices 108 (two such user devices 108a, 108b are shown), and one or more merchants 112. The user devices 108 and merchants 112 can be in electronic communication with transaction processing system 106 and with each other over a network 110. The stand-in system 102, data store 104, and transaction processing system 106 can be in electronic communication with each other via network 110 or another network.

The stand-in system 102 can include a processor 114 and a memory 116. Memory 116 can be a non-transitory, computer-readable media that contains instruction that, when executed by processor 114, cause the stand-in system 102 to perform one or more of the steps, processes, methods, operations, etc. described herein with respect to the stand-in system 102. The stand-in system 102 can include one or more functional modules embodied in the memory 116. The functional modules can include a domain module 118, a service module 120, an allocation module 122, a stand-in module 124, a cache module 126, and a processing module 128.

The instant disclosure refers to accounts, users, electronic transactions, and other electronic activity. Such accounts may be accounts common to a particular service provider, a particular network, a particular electronic activity processor, etc. For example, the accounts may be accounts with the transaction processing system 106, and the users may be legitimate users associated with those accounts. The electronic transactions and other activity may be transactions processed by, or other activity in or through, the transaction processing system 106, and/or transactions and activity outside of the transaction processing system 106. Although this disclosure refers to electronic transactions as context for the novel methods and systems, it should be understood that such methods and systems may be applied to or in the context of a wide variety of computing actions, some of which may not be considered transactions. For example, where past transactions are considered herein, past computing actions may more broadly be considered. Similarly, where present transactions are responded to herein, present computing actions may more broadly be responded to.

Stand-in system 102 can include domain module 118. Stand-in system 102 can generate and provide a service request to domain module 118. For example, the service request can be based on an electronic transaction at transaction processing system 106. Domain module 118 can be configured to perform a certain function such as, for example, fulfillment evaluation, risk compliance, IP address validation, or electronic transaction fulfillment, among other functions.

Domain module 118 can be configured to receive a service request and can leverage a subset of micro-services at the domain level of domain module 118 to fulfill the service request. The “micro-services” can also be referred to herein as “services.” In some embodiments, domain module 118 can be one of a plurality of domains of the stand-in system 102. In other embodiments, domain module 118 can include a plurality of domains of stand-in system 102 and the domains can be categorized based on a processing task(s).

Stand-in system 102 can include service module 120. Service module 120 can include one or more micro-services. Service module 120 can be configured to utilize the one or more micro-services, or a subset thereof, to fulfill a service request at domain module 118. Service module 120 can utilize the micro-services to perform one or more processing operations and the micro-services can provide a determination as output in response to the service request. The micro-services allocated to processing the request can be based on the service request. In some embodiments, the micro-services allocated to processing the request can be based on the context of the service request. In some embodiments, the service module 120 can include one or more micro-services of a given domain. In other embodiments, the service module 120 can include a plurality of micro-services, and each of the plurality of micro-services can be allocated to a respective one of the plurality of domains of stand-in system 102.

Stand-in system 102 can include stand-in module 124. Stand-in module 124 can be configured to provide stand-in services to domain module 118 or service module 120. That is, stand-in module 124 can be configured to provide stand-in services for any or all of the micro-services at a domain. In some embodiments, a micro-service at domain module 118 may be unavailable and the stand-in module 124 can provide a stand-in service to perform the processing operations for the unavailable micro-service. In other embodiments, one or more micro-services at domain module 118 may be unavailable and the stand-in module 124 can provide one or more stand-in services to perform the respective processing operations for the unavailable one or more micro-services.

Stand-in system 102 can include a machine learning model. In some embodiments, stand-in module 124 can include the machine learning model. The machine learning model can be configured to utilize one or more techniques and or algorithms to perform operations including, but not limited to, determining a context of a service request, obtaining data from the service request, identifying an unavailable micro-service, identifying an application programming interface (API), identifying a key or set of keys, retrieving data from a cache using the key or set of keys, performing a processing task of the unavailable micro-service using the retrieved data, providing an output to the domain module 118 based on the processing, or any combination thereof, among other operations. For example, the machine learning model may apply one or more natural language processing (NLP) techniques to a service request to determine the context of the service request.

One or more of the operations performed by the machine learning model can be based on the service request or a context of the service request. For example, based on the context of the service request, the machine learning model can identify a subset of micro-services of domain module 118 that will be utilized to fulfill the service request, and the machine learning model can determine if any of the subset of micro-services are unavailable to fulfill the service request.

Stand-in module 124 can be configured to train the machine learning model to enable providing the stand-in service functionality to the domain module 118 for an unavailable service. When a micro-service is utilized to fulfill a service request, the data generated by the micro-service can be stored as training data in a data store. In some embodiments, the training data can include request data, execution data, response data, other types of data associated with the service request fulfillment by the service, or any combination thereof. The machine learning model can then be utilized to train the machine learning model. For example, the data produced from a particular micro-service fulfilling service requests can be utilized to generate a corresponding training dataset, and the machine learning model can be trained using the training dataset to enable the model to serve as a stand-in service if the micro-service becomes unavailable. In some embodiments, the training data can include testing data. For example, testing data can be fed into the model to determine a model's performance.

When a new service is introduced to domain module 118, the machine learning model can be trained through cold start model training or hard start model training. As used herein, “cold start” refers to training a model from scratch without using prior training data. As used herein, “hard start” refers to training a model prior to introducing the model into the live production environment. For example, the stand-in service can be run in a test environment and run on shadow traffic or supervised data prior to implementation into the live production environment.

Stand-in system 102 can include cache module 126. The cache module 126 can provide a cache for storing data generated at the domain module 118. The data stored in the cache can include any of a plurality of data including, but not limited to, service request data, user data, account data, device data, user behavior data, historical data, output data from the micro-services, or any combination thereof, among other types of data. In some embodiments, the data from service requests that is stored in the cache can be processed by the stand-in system 102, as will be further described herein.

Cache module 126 can generate a key set for the service request obtained at the domain module 118. The key set can be generated using data of the service request, intended service, api name, or any combination thereof. In some embodiments, the key set can include an identifier. The key set can be utilized to retrieve data from the cache that is a match to the key. For example, a key set can include “ServiceA_api-name_user” and “ServiceA_api-name_merchant,” and the data associated with the key-value pair can be stored in cache for a defined TTL. In some embodiments, the key can be used to retrieve data that is an exact match to the data of the key set. In other embodiments, the key can be used to retrieve data that is a similar to the data of the key set if an exact match is not found (e.g., generic match).

When a request is made to domain module 118, a parallel call can be made to stand-in module 124, and the stand-in module 124 can retrieve data from the service request based on the context. In some embodiments, the stand-in module 124 can generate a key set for the request using, for example, the data from the service request, intended service, and API name, and the stand-in module 124 can invoke the cache using this key to retrieve data corresponding to a match with the key from the cache. The data (e.g., hydrated dataset) retrieved using the key set can be provided to the stand-in module 124 for service specific execution. That is, the machine learning model of stand-in module 124 can obtain the data retrieved from the cache to perform the processing tasks of the identified unavailable micro-service.

Stand-in system 102 can include processing module 128. Processing module 128 can be configured to process data generated at domain module 118 and by service module 120. In some embodiments, the processing of the data can include extracting, enriching, aggregating, comparing, filtering, or any combination thereof, among other processes.

Processing module 128 can be configured to extract data and link the extracted data to a customer. In some embodiments, the processing module 128 can extract data from a data log for a micro-service. When the micro-service performs a processing task to fulfill a service request, the data log can be generated at the domain module 118. The data log can include, for example, service request data, execution data, response data, other types of data associated with the service request fulfillment by the service, or any combination thereof.

Processing module 128 can enrich the data. In some embodiments, processing module 128 can enrich the extracted data. Each request and response from the micro-services can be tagged with an identifier, and the processing module 128 can identify connections between the request pattern, the service request data, and the data output by the micro-service including the response output by the micro-service, based on the associated identifier.

Processing module 128 can aggregate the data. In some embodiments, processing module 128 can include an aggregator configured to aggregate the enriched data along multiple dimensions to enable linking the data and determine dependencies in the data. In addition, processing module 128 can filter the data. In some embodiments, processing module 128 can include a comparator configured to filter similar data from the aggregated dataset.

Processing module 128 can link the data to each other or to one or more other objects. In some embodiments, processing module 128 can link each data point in the aggregated dataset to one or more services. In other embodiments, processing module 128 can link each data point in the aggregated dataset to one or more customers. The processing module 128 can link the data to produce a processed dataset (e.g., hydrated dataset) that can be utilized by stand-in system 102 to provide the stand-in service functionality of the present disclosure. For example, processing module 128 can construct a data dependency tree from the processed data. In another example, processing module 128 can contract a data graph from the processed data. In addition, processing module 128 can create a processed dataset (e.g., hydrated dataset) that is linked to show relationships between the context data and the loaded data, and the dataset can also include default values for data that may not be available.

The processing module 128 can store the processed dataset in the cache. The data in the processed dataset can be associated with corresponding identifiers based on the context of the data. The identifiers enable the data stored in the cache to be retrieved by a machine learning model when the model serves as a stand-in service for an unavailable service based on the identifier associated with the data matching a key determined by the machine learning model based on the context of the service request.

Users can initiate electronic transactions, review electronic transactions, complete transactions, etc. on user computing devices 108 through the transaction processing system 106. Accordingly, transaction processing system 106 can receive from user computing devices 108 instructions to initiate a transaction, an instruction to accept or complete a transaction, an instruction to review one or more transactions, an instruction to retract a transaction, etc., and can respond by performing or facilitating the requested user action. Accordingly, user activity as discussed herein can include transactions instructed through the transaction processing system 106, in some embodiments, and/or user activity on one or more platforms, networks, etc. Such transactions can include, for example, a computing transaction such as a file creation, a revision to a file, an electronic communication, a financial transaction (or component thereof), a real-estate transaction (or component thereof), a service request, or any other electronic transaction. Additionally, or alternatively, user activity according to the present disclosure can be or may include an event associated with a user, such as a user navigation to a webpage, a user search request, etc.

The transaction processing system 106 can be associated with a particular electronic user interface and/or platform through which a user performs electronic transactions. The electronic user interface can be embodied in a website, mobile application, etc. Accordingly, the transaction processing system 106 can be associated with or wholly or partially embodied in one or more servers, which server(s) can host the interface, and through which the user computing devices 108 can access the user interface.

The user computing devices 108 can be respectively associated with different user accounts. That is, user computing device 108a can be associated with a first user account, and user computing device 108b can be associated with a second user account. Where user computing devices are discussed herein, it can be assumed that different devices are associated with different user accounts for convenience of description, though of course a single user account can be accessed from multiple devices in practical use.

Various embodiments herein can employ artificial-intelligence, neural network models, deep learning neural network models, deep q-learning neural network models, and/or machine learning systems and techniques to facilitate training the models from scratch, training the models using audit data, training the models using reinforcement learning for continual learning, determining decisions as output predictions based on applying the input data to the models, other processes, or any combination thereof. Although the one or more embodiments are described in the present disclosure in the context of determining decisions by services at a domain in response to the context of electronic transactions, it is to be appreciated that the various embodiments can be utilized in a networked system such as, for example, system 100 for any of a plurality of purposes including, but not limited to, fulfilling transactions, authentications, content recommendations, managing threats including identifying suspicious or fraudulent transactions, learning user behavior, context-based scenarios, preferences, etc. in order to facilitate the system 100 taking automated action with high degrees of confidence for the computing devices performing transactions on the network 110. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or M.L. components herein such as discussed above in context of stand-in module 124 and the other functional modules of stand-in system 102 in FIG. 1 can include artificial intelligence component(s) which can employ an artificial intelligence (AI) model, neural network or a neural network model, or M.L. or a M.L. model, that can learn to perform the above or below described functions (e.g., via training data and/or feedback data). In some embodiments, the stand-in system 102 can include a machine learning model configured to utilize natural language processing (NLP) to determine a context of a service call based on text data. In other embodiments, the stand-in system 102 can include a machine learning model configured to utilize one or more techniques to determine a context of a service call based on text data, image data, sequential data, other types of data, or any combination thereof. In some embodiments, the model can include, for example, a small language model, medium language model, large language model.

In some embodiments, the system 100 and/or the stand-in system 102 can include an M.L. module including an A.I. and/or M.L. model that can be trained (e.g., via supervised and/or unsupervised techniques) to perform one or more of the above or below-described functions using training data including various context conditions that correspond to various management operations. In one example, an A.I. and/or M.L. model can further learn (e.g., via supervised and/or unsupervised techniques) to perform the above or below-described functions using training data including feedback data, where such feedback data can be collected and/or stored (e.g., in memory 116 or datastore 104) by stand-in module 124 or by an M.L. component of stand-in system 102. In this example, such feedback data can include the various instructions described above/below that can be input, for instance, to a system herein, over time in response to observed/stored context-based information.

A.I./M.L. components herein can initiate an operation(s) associated with the one or more functional modules 118, 120, 122, 124, 126, 128 of the stand-in system 102 based on a defined level of confidence determined using information (e.g., feedback data). For example, based on learning to perform such functions described above using feedback data, performance information, and/or past performance information herein, an M.L. model herein can initiate an operation associated with providing decisions as output predictions based on the input data applied to the model including context data from the service request including, but not limited to, user data, account data, device data, historical data, inventory data, user behavior data, sequence data, other types of data at stand-in system 102 or transaction processing system 106, or any combination thereof. In another example, based on learning to perform such functions described above using feedback data, an M.L. model can be trained from scratch, trained using reinforcement learning, trained using continual learning, or trained using data based on the activity of the services at the domain.

In an embodiment, the M.L. model can perform a utility-based analysis that factors cost of initiating the above-described operations versus benefit. In this embodiment, an artificial intelligence component can use one or more additional context conditions to determine an appropriate distance threshold or context information, or to determine an update for a tuning model.

To facilitate the above-described functions, an M.L. model herein can perform classifications, correlations, inferences, and/or expressions associated with principles of artificial intelligence. For instance, an M.L. model can employ an automatic classification system and/or an automatic classification. In one example, the M.L. model can employ a probabilistic and/or statistical-based analysis (e.g., factoring into the analysis utilities and costs) to learn and/or generate inferences. The M.L. model can employ any suitable machine-learning based techniques, statistical-based techniques and/or probabilistic-based techniques. For example, the M.L. model can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the M.L. model can perform a set of machine-learning computations. For instance, the M.L. model can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

In some embodiments, the M.L. model can utilize one or more clustering techniques including, but not limited to, density-based clustering, distribution-based clustering, centroid-based clustering, hierarchical based clustering, or any combinations thereof. In addition, the one or more models can apply one or more clustering algorithms including, but not limited to, k-means clustering algorithms, density-based clustering algorithms, Gaussian mixture model algorithms, balanced iterative reducing and clustering using hierarchies (BIRCH) algorithms, propagation clustering algorithms, mean-shift clustering algorithms, order point clustering, agglomerative hierarchy clustering algorithms, other algorithms, or any combinations thereof. For example, the model can apply the one or more centroid-based clustering models to determine clusters using k-means clustering algorithms.

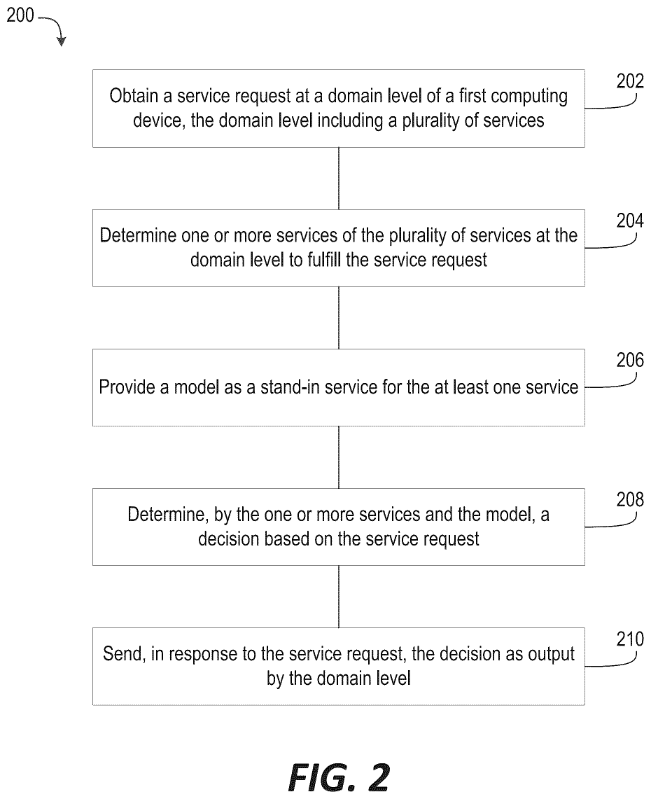

FIG. 2 is a flow chart illustrating an example method 200 of providing the stand-in service functionality. The method 200, or one or more portions of the method 200, can be performed by the functional modules of stand-in system 102 in conjunction with data store 104, transaction processing system 106, network 110, or any combination thereof, and thus can be computer-implemented. In some embodiments, the method 200 can be performed by stand-in system 102 in conjunction with data store 104, transaction processing system 106, user computing devices 108, one or more merchants 112, network 110, or any combination thereof.

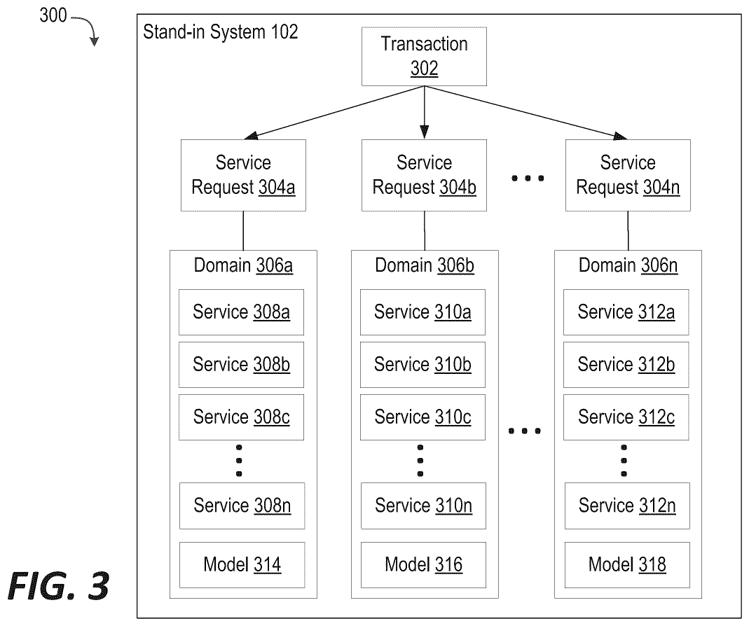

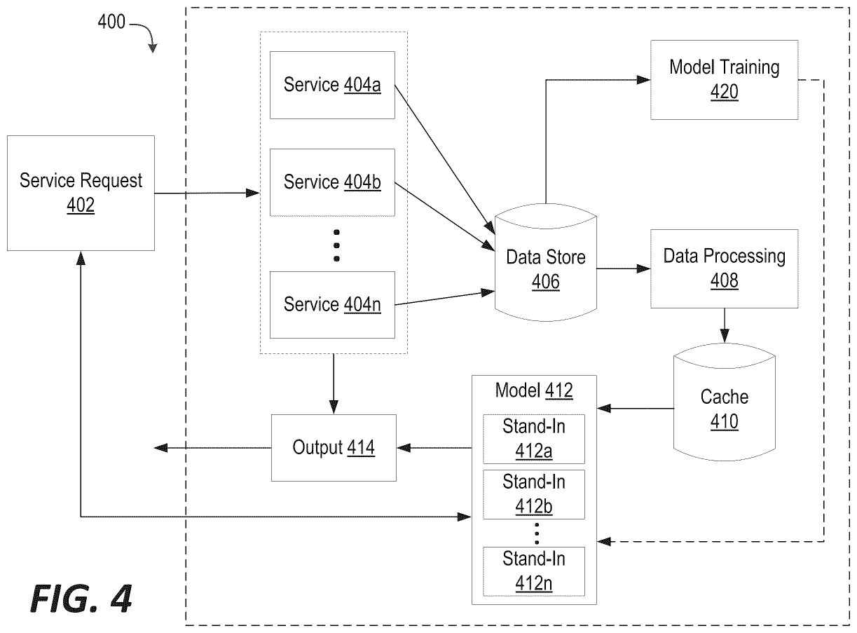

FIG. 3 is a block diagram view of an example system 300 for performing the method 200 of FIG. 2. FIG. 4 is a block diagram view of an example domain level in system 400 for performing the method 200 of FIG. 2. The method 200 of FIG. 2 will be described in conjunction with the system 300 of FIG. 3 and the system 400 of FIG. 4. In some embodiments, the system 100 can include the system 300 embodied by one or more functional modules of stand-in system 102. In some embodiments, the system 100 can include the system 400 embodied by one or more functional modules of stand-in system 102.

At 202, the method 200 can include obtaining a service request at a domain level of a first computing device. The domain level can be configured to perform a certain function such as, for example, fulfillment evaluation, risk compliance, IP address validation, or electronic transaction fulfillment, as discussed above with respect to domain module 118 of stand-in system 102 in FIG. 1. The domain level can include a plurality of services. In some embodiments, the first computing device can include a plurality of domain levels, and each domain level can include a plurality of services. In FIG. 3, for electronic transaction 302, one or more service requests 304a, 304b, 304n can be generated in stand-in system 102, and the service request 304a can be provided to domain 306a for processing by the corresponding micro-services 308a, 308b, 308c, 308n of the domain 306a. In FIG. 4, the service request is shown as service request 402.

At 204, the method 200 can include determining one or more services of the plurality of services at the domain level to fulfill the service request. In some embodiments, the one or more services can be a subset of the plurality of services at the domain level. The one or more services that are needed to fulfill the service request can be determined based on a context of the service request. The one or more services can be determined based on, for example, user data, account data, transaction data, device data, behavioral data, historical data, other types of data, or any combination thereof. Referring to FIG. 3, a subset of services 308a, 308b, 308c, 308n at domain 306a can be determined to fulfill service request 304a. In FIG. 4, a subset of services 404a, 404b, 404c, 404n at the domain level of system 400 can be determined to fulfill service request 402.

At 206, the method 200 can include in response to determining at least one service of the one or more services is unavailable, providing a model as a stand-in service for the at least one service. The model can be a machine learning model of stand-in module 124, as discussed above with respect to FIG. 1. The model is shown as model 314 at domain 306a, model 316 at domain 306b, and model 318 at domain 306n, in FIG. 3. Referring to FIG. 4, the model is shown as model 412, and the model 412 can be configured to serve as stand-in for any of the services 404a, 404b, 404n, as shown by stand-ins 412a, 412b, 412n.

At 208, the method 200 can include determining, by the one or more services and the model, a decision based on the service request. The model can be configured to perform one or more operations including, for example, determining a context of a service request, obtaining data from the service request, identifying an unavailable micro-service, identifying an application programming interface (API), identifying a key or set of keys, retrieving data from a cache using the key or set of keys, performing a processing task of the unavailable micro-service using the retrieved data, providing an output to the domain module 118 based on the processing, or any combination thereof, among other operations, as discussed with respect to the machine learning model of stand-in module 124 in FIG. 1.

The model can serve as a stand-in service for the unavailable service at the domain level including performing one or more processing tasks of the unavailable service so that the domain can provide the decision as output in response to the service request based on the processing of the service request by the one or more services and by the stand-in service provided by the model. Referring to FIG. 4, model 412 is shown as being configured to provide stand-in services 412a, 412b, 414n corresponding to the services 404a, 404b, 404n at the domain level of system 400, and the decision from the one or more services and the model 412 is shown as output 414.

At 210, the method 200 can include sending, in response to the service request, the decision as output by the domain level. The decision can be sent to stand-in system 102 or transaction processing system 106 of FIG. 1, and the transaction associated with the service request can be, for example, authorized, completed, rejected, flagged, or some other further action can be taken in response to the decision. For example, a hold can be placed on a user account associated with an electronic transaction based on the decision returned from a domain level indicating that the transaction request may be a fraudulent transaction. In some embodiments, the decision can be sent to one or more of the functional modules of stand-in system 102 and the stand-in system 102 can aggregate the decision output by the domain with one or more other decisions from one or more other domains to determine what further action to perform. In FIG. 4, the domain level of system 400 is shown sending the output 414 in response to the service request 402.

Method 200 can further include obtaining, by the first computing device, a user request from a second computing device and identifying one or more domain levels to fulfill the user request based on a context of the user request. In some embodiments, the one or more domain levels can include the domain level at, for example, operation 202. As shown in FIG. 1, the user request can be an electronic transaction at transaction processing system 106 such as, for example, between user computing devices 108 and merchant 112 using the network 110 of system 100. The user request can be an electronic transaction such as, for example, transaction 302 as shown in FIG. 3.

Method 200 can further include determining one or more service requests based on the user request and allocating each service request of the one or more service requests to a respective domain level of the one or more domain levels. As shown in FIG. 3, the one or more service requests can include one or more of the service requests 304a, 304b, 304n and the one or more domain levels can include one or more of the domains 306a, 306b, 306n.

Method 200 can further include training the model using a training dataset corresponding to an activity of the plurality of services. In some embodiments, the trained model can be configured to serve as a stand-in for the plurality of services at the domain level. In other embodiments, the trained model can be trained using the training dataset to serve as a stand-in for any of the plurality of services at the domain level. The training dataset can include data obtained from a data store, and the model can be trained with the training dataset to provide the trained model. As shown in FIG. 4, the model training can be performed at block 420 using a training dataset obtained from data store 406 to enable the model 412 to serve as a stand-in for the services 404a, 404b, 404n.

The training data can include, for example, service request data, data generated based on the processing of the service request by the services, and data corresponding to the decisions output by the services, such as discussed above with respect to stand-in module 124. In some embodiments, the training data can correspond to activity of a service of the plurality of services, and the model can be trained using the training data to enable the model to serve as the stand-in for the service of the plurality of services. In other embodiments, the training data can correspond to activity of the plurality of services, and the model can be trained using the training data to enable the model to serve as the stand-in for any one of the plurality of services of the domain based on the context of the service request determined by the model.

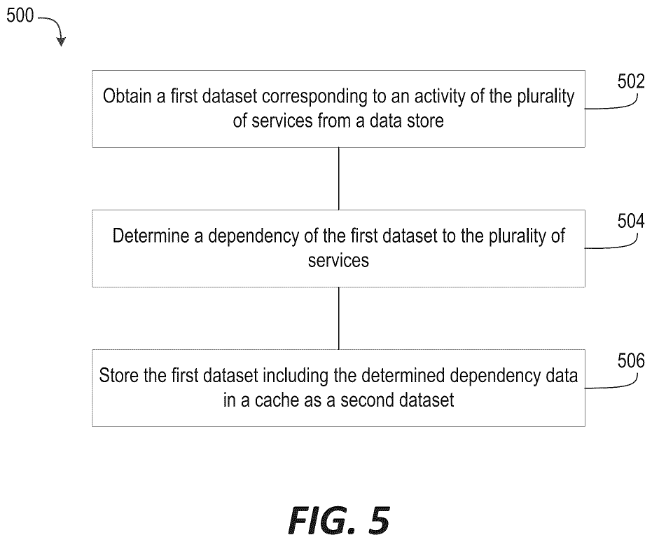

FIG. 5 is a flow diagram of an example method 500 for processing data at a domain level, according to some embodiments. The method 500, or one or more portions of method 500, can be performed by the one or more functional modules of stand-in system 102 in conjunction with data store 104, transaction processing system 106, network 110, or any combination thereof, and thus can be computer-implemented. The method 500 can be an embodiment of operations 206, 208 of method 200 in FIG. 2.

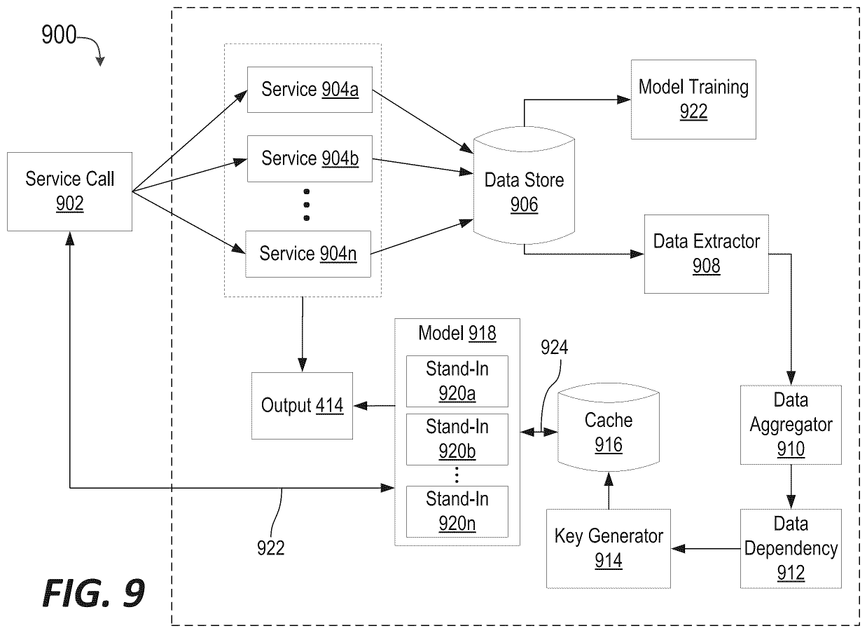

FIG. 9 is a block diagram of an example domain level of system 900, according to some embodiments. The system 900 can perform one or more methods including methods 200, 500, 600, 700, 800, or portions thereof. In some embodiments, system 100 can include the system 900 embodied by one or more of the functional modules of stand-in system 102 in FIG. 1. The method 500 will be described in conjunction with the system 900 of FIG. 9.

At 502, the method 500 can include obtaining a first dataset corresponding to an activity of the plurality of services from a data store. The first dataset can include, for example, service request data based on the context of the service request, log data generated based on the services performing their processing tasks, data output by the services, other data, or any combination thereof, as discussed above with respect to processing module 128 of FIG. 1. In some embodiments, the first dataset can correspond to activity of a service of the plurality of services at the domain level, and the first dataset can include service request data based on the context of the service request, log data generated based on the service performing a processing task, data output by the service, other data, or any combination thereof. As shown in FIG. 9, the first dataset can be obtained from data store 906, and the first dataset can correspond to activity of the plurality of services 904a, 904b, 904n, or the first dataset can correspond to activity of one of the plurality of services 904a, 904b, 904n.

In some embodiments, the first dataset obtained from the data store can correspond to the activity of the plurality of services since a last update. In other embodiments, the first dataset obtained from the data store can correspond to the activity of a service of the plurality of services since a last update.

At 504, the method 500 can include determining a dependency of the data in the first dataset to the plurality of services. Determining the dependency of a dataset links the data to one or more objects to show relationships, as discussed above with respect to processing module 128. In some embodiments, determining the dependency of a dataset can include linking data to each other. In other embodiments, determining the dependency of a dataset can include linking data to one or more other objects. For example, the linking shows the relationship between the context data and the loaded data. In some embodiments, the one or more other objects can include one or more services. In other embodiments, the one or more other objects can include one or more customers.

Determining the dependency of a dataset can include providing data linked at multiple dimensions (e.g., hydrated dataset). In some embodiments, determining the dependency of a dataset can include determining a data dependency tree from the processed data. In other embodiments, determining the dependency of a dataset can include determining a data graph from the processed data. As shown in FIG. 9, the dependency of a dataset can be determined at block 912.

At 506, the method 500 can include storing the first dataset including the determined dependency data in a cache as a second dataset. The model can utilize the data stored in the cache including the second dataset to enable the model to serve as the stand-in service for the at least one service that may be unavailable at the domain, such as described above with respect to cache module 126 and processing module 128 of FIG. 1. As shown in FIG. 9, the cache is shown as cache 916.

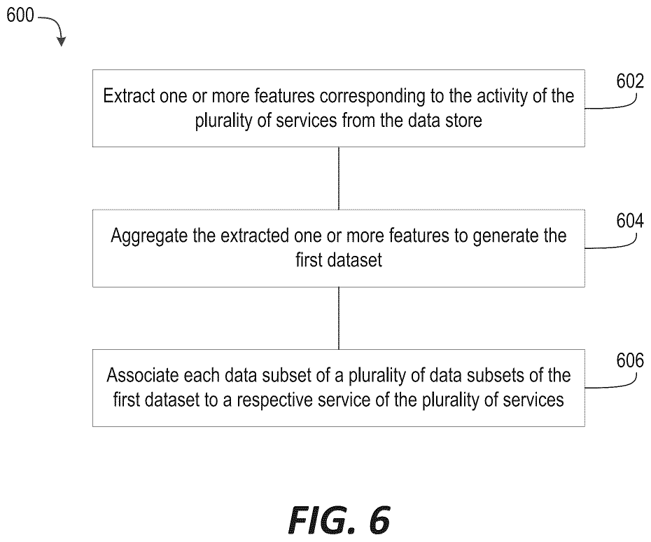

FIG. 6 is a flow diagram of an example method 600 for processing data at a domain level, according to some embodiments. The method 600, or one or more portions of method 600, can be performed by the one or more functional modules of stand-in system 102 in conjunction with data store 104, transaction processing system 106, network 110, or any combination thereof, and thus can be computer-implemented. The method 600 can be an embodiment of operations 206, 208 of method 200 in FIG. 2, or operation 504 of method 500 in FIG. 5. The method 600 will be described in conjunction with the system 900 of FIG. 9.

At 602, the method 600 can include extracting one or more features corresponding to the activity of the plurality of services from the data store. In some embodiments, determining the dependency of the first dataset to the plurality of services can include extracting one or more features corresponding to the activity of the plurality of services from the data store, as discussed above with respect to processing module 128 of FIG. 1. In this regard, the first dataset can include the one or more features and can correspond to the service request data, log data of the activity of the services, output data from the services, or any combination thereof, among other features. In addition, as shown in FIG. 9, the features can be extracted from data obtained from data store 906, and the features can correspond to activity of the plurality of services 904a, 904b, 904n, or the features can correspond to activity of one of the plurality of services 904a, 904b, 904n.

The extracted features can be utilized in the training dataset to train the machine learning model. In some embodiments, the extracted features can correspond to data associated with a service of the plurality of services, and one or more of the features can be included in the training dataset to train the machine learning model. In this regard, the data generated at the domain level based on the activity of the plurality of services can be utilized to perform continual learning of the machine learning model.

At 604, the method 600 can include aggregating the extracted one or more features to generate the first dataset. In some embodiments, determining the dependency of the first dataset to the plurality of services can include aggregating the extracted one or more features to generate the first dataset, as discussed above with respect to processing module 128 of FIG. 1.

At 606, the method 600 can include associating each data subset of a plurality of data subsets of the first dataset to a respective service of the plurality of services. In some embodiments, determining the dependency of the first dataset to the plurality of services can include associating each data subset of a plurality of data subsets of the first dataset to a respective service of the plurality of services. That is, the first dataset can include a plurality of data points, and determining the data dependency can include allocating the data to a respective one of the plurality of data subsets. In some embodiments, the plurality of data subsets can correspond to a service, API, service call pattern, or user, among other characteristics. In FIG. 9, determining the dependency of the data in the first dataset including associating the data with a data subset can be performed at block 912.

In addition, each data subset can include one or more data points of the first dataset and can include representations indicative of the relationship between the data in the data subset to each other and to other objects including, for example, services of the domain level, users, APIs, service call patterns, etc. For example, the first dataset can be a data dependency tree and can include representations indicative of the relation between context data and loaded data. In some embodiments, the first dataset can include default values for data that may not be available.

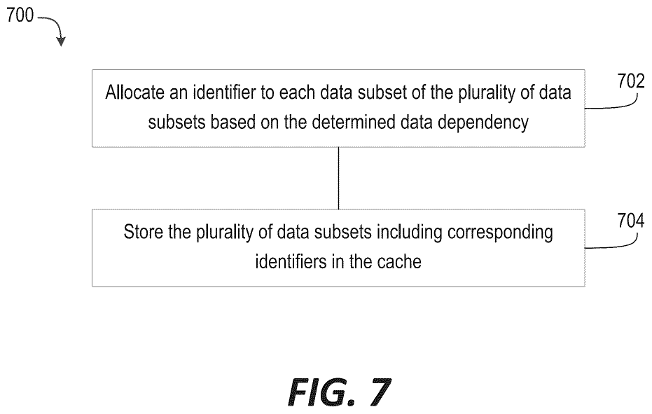

FIG. 7 is a flow diagram of an example method 700 for processing the data at a domain level, according to some embodiments. The method 700, or one or more portions of method 700, can be performed by the one or more functional modules of stand-in system 102 in conjunction with data store 104, transaction processing system 106, network 110, or any combination thereof, and thus can be computer-implemented. The method 700 can be an embodiment of operations 206, 208 of method 200 in FIG. 2, operation 504, 506 in method 500 of FIG. 5, or operations 602, 604, 606 of method 600 in FIG. 6. The method 700 will be described in conjunction with the system 900 of FIG. 9.

At 702, the method 700 can include associating an identifier with each data subset of the plurality of data subsets of the first dataset based on the determined data dependency. That is, each data subset of the plurality of data subsets can include a unique identifier associated with therewith based on the determined dependency of the data. The identifier can enable retrieving a corresponding data subset associated with the identifier from the cache based on a key generated by the model. In some embodiments, the identifier can correspond to a key-value pair for retrieving the corresponding data subset of the plurality of data subsets from the cache by the model. In FIG. 9, the data subsets can be associated with an identifier at block 914.

At 704, the method 700 can include storing the plurality of data subsets including corresponding identifiers in the cache. The identifiers enable the model to retrieve a corresponding data subset from the cache. The identifier can be based on a context of the service request, the service, the API name, or any combination thereof, among other identifiers. In some embodiments, the identifier can be based on a context of the service request. In other embodiments, the identifier can be based on the associated service. In yet other embodiments, the identifier can be based on an API name. In FIG. 9, the first dataset including the identifier can be stored in cache 916.

Accordingly, when a service request call is made to the domain level, a parallel call can be made to the machine learning model and the model can generate a key set for the request based on, for example, the context of the service request data, intended service, API name, among other characteristic identifiers. The model can query and retrieve data corresponding to one or more of the data subsets from the cache based on the key set based on a key matching the identifier associated with each data subset of the plurality of data subsets stored in the cache.

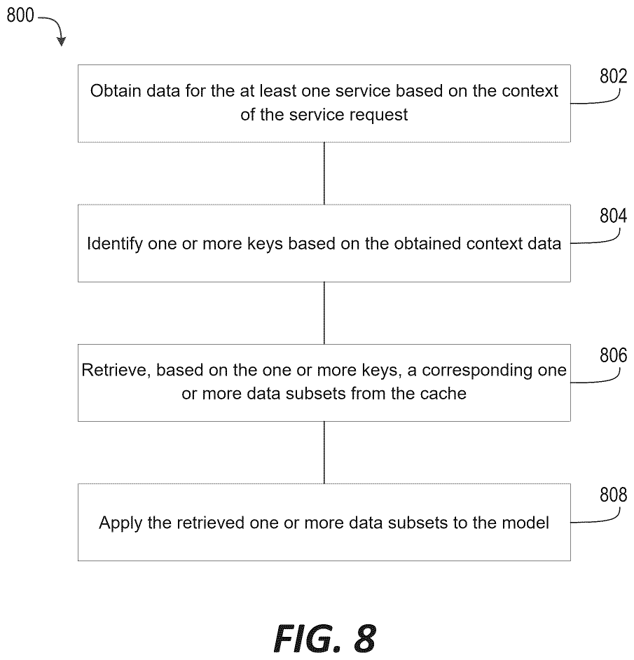

FIG. 8 is a flow diagram of an example method 800 for providing the stand-in service, according to some embodiments. The method 800, or one or more portions of method 800, can be performed by the one or more functional modules of stand-in system 102 in conjunction with data store 104, transaction processing system 106, network 110, or any combination thereof, and thus can be computer-implemented. The method 800 can be an embodiment of operations 206, 208 of method 200 in FIG. 2, operation 504, 506 in method 500 of FIG. 5, operations 602, 604, 606 of method 600 in FIG. 6, or operations 702, 704 of method 700 in FIG. 7. The method 800 will be described in conjunction with the system 900 of FIG. 9.

At 802, the method 800 can include obtaining data for the at least one service based on the context of the service request.

In some embodiments, obtaining data for the at least one service based on the context of the service request can include the model applying one or more model techniques or algorithms to the data of the service request to understand the context of the service request and to enable the model to provide the stand-in service functionality. In some embodiments, providing the stand-in service functionality can include obtaining data corresponding to the context data from the service request. In FIG. 9, the data obtained for the at least one service is shown at 922.

At 804, the method 800 can include identifying one or more keys based on the obtained context data. In some embodiments, the machine learning model can identify generate a key set including the one or more keys based on the data obtained from the service request. Each key in the key set can be generated based on, for example, the context data of the service request, the service, the API name, or any combination thereof, among other identifiers.

At 806, the method 800 can include retrieving, based on the one or more keys, a corresponding one or more data subsets from the cache. In some embodiments, the machine learning model can retrieve the corresponding one or more data subsets from the cache utilizing the one or more keys based on each key corresponding to a key-value pair with the identifier associated with each respective data subset stored in the cache. In FIG. 9, the retrieving of the data subset using the keys is shown at 924.

At 806, the method 800 can include applying the retrieved one or more data subsets to the model. Using the key set, the one or more data subsets can be retrieved cache to form a dataset (e.g., hydrated dataset), and the model can utilize the dataset pulled from the cache to serve as the stand-in service for the at least one service that may be unavailable at the domain level. In this regard, the model can utilize the data retrieved from the cache to perform the processing tasks in place of the unavailable service independently or in parallel with the other services allocated to fulfilling the service request.

The model can output a decision is based on the one or more data subsets applied to the model. In some embodiments, the model and the one or more services allocated to fulfilling the service request can output the decision, the model providing the stand-in service for the at least one service that may be unavailable using the one or more data subsets retrieved from the cache.

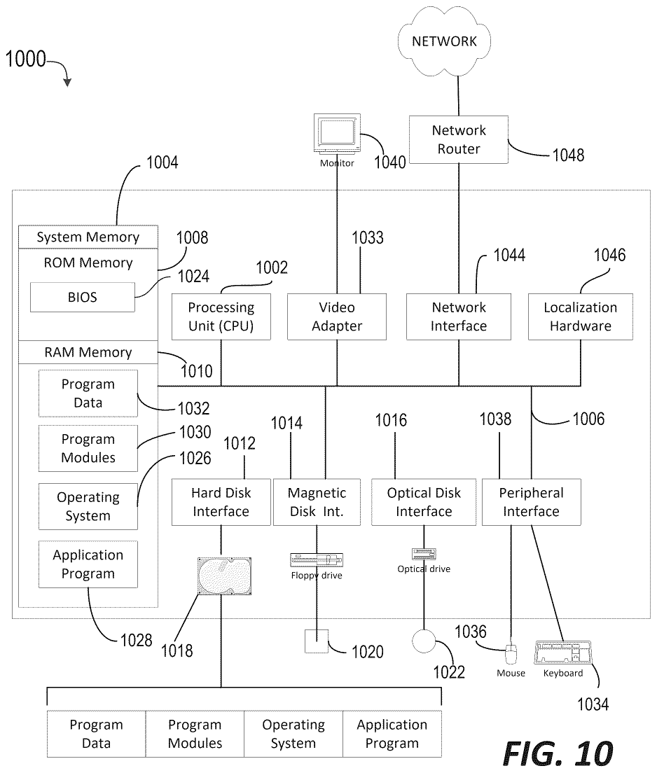

FIG. 10 is a block diagram of an example computing system 1000, according to some embodiments.

The computing system 1000 can be, for example, a desktop computer, laptop, smartphone, tablet, or any other such device having the ability to execute instructions, such as those stored within a non-transient, computer-readable medium. Furthermore, while described and illustrated in the context of a single computing system 1000, those skilled in the art will also appreciate that the various tasks described hereinafter can be practiced in a distributed environment having multiple computing systems 1000 linked via a local or wide-area network in which the executable instructions can be associated with and/or executed by one or more of multiple computing systems 1000.

In its most basic configuration, computing system environment 1000 typically includes at least one processing unit 1002 and at least one memory 1004, which can be linked via a bus 1006. Depending on the exact configuration and type of computing system environment, memory 1004 can be volatile (such as RAM 1010), non-volatile (such as ROM 1008, flash memory, etc.) or some combination of the two. Computing system environment 1000 can have additional features and/or functionality. For example, computing system environment 1000 can also include additional storage (removable and/or non-removable) including, but not limited to, magnetic or optical disks, tape drives and/or flash drives. Such additional memory devices can be made accessible to the computing system environment 1000 by means of, for example, a hard disk drive interface 1012, a magnetic disk drive interface 1014, and/or an optical disk drive interface 1016. As will be understood, these devices, which would be linked to the system bus 1006, respectively, allow for reading from and writing to a hard disk 1018, reading from or writing to a removable magnetic disk 1020, and/or for reading from or writing to a removable optical disk 1022, such as a CD/DVD ROM or other optical media. The drive interfaces and their associated computer-readable media allow for the nonvolatile storage of computer readable instructions, data structures, program modules and other data for the computing system environment 1000. Those skilled in the art will further appreciate that other types of computer readable media that can store data can be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media can be part of computing system environment 1000.

A number of program modules can be stored in one or more of the memory/media devices. For example, a basic input/output system (BIOS) 1024, containing the basic routines that help to transfer information between elements within the computing system environment 1000, such as during start-up, can be stored in ROM 1008. Similarly, RAM 1010, hard drive 1018, and/or peripheral memory devices can be used to store computer executable instructions comprising an operating system 1026, one or more applications programs 1028, other program modules 1030, and/or program data 1032. Still further, computer-executable instructions can be downloaded to the computing environment 1000 as needed, for example, via a network connection. The applications programs 1028 can include, for example, a browser, including a particular browser application and version, which browser application and version can be relevant to determinations of correspondence between communications and user URL requests, as described herein. Similarly, the operating system 1026 and its version can be relevant to determinations of correspondence between communications and user URL requests, as described herein.

An end-user can enter commands and information into the computing system environment 1000 through input devices such as a keyboard 1034 and/or a pointing device 1036. While not illustrated, other input devices can include a microphone, a joystick, a game pad, a scanner, etc. These and other input devices would typically be connected to the processing unit 1002 by means of a peripheral interface 1038 which, in turn, would be coupled to bus 1006. Input devices can be directly or indirectly connected to processor 1002 via interfaces such as, for example, a parallel port, game port, firewire, or a universal serial bus (USB). To view information from the computing system environment 1000, a monitor 1040 or other type of display device can also be connected to bus 1006 via an interface, such as via video adapter 1033. In addition to the monitor 1040, the computing system environment 1000 can also include other peripheral output devices, not shown, such as speakers and printers.

The computing system environment 1000 can also utilize logical connections to one or more computing system environments. Communications between the computing system environment 1000 and the remote computing system environment can be exchanged via a further processing device, such a network router 1048, that is responsible for network routing. Communications with the network router 1048 can be performed via a network interface component 1044. Thus, within such a networked environment, e.g., the Internet, World Wide Web, LAN, or other like type of wired or wireless network, it will be appreciated that program modules depicted relative to the computing system environment 1000, or portions thereof, can be stored in the memory storage device(s) of the computing system environment 1000.

The computing system environment 1000 can also include localization hardware 1046 for determining a location of the computing system environment 1000. In embodiments, the localization hardware 1046 can include, for example only, a GPS antenna, an RFID chip or reader, a WiFi antenna, or other computing hardware that can be used to capture or transmit signals that can be used to determine the location of the computing system environment 1000. Data from the localization hardware 1046 can be included in a callback request or other user computing device metadata in the methods of this disclosure.

The computing system, or one or more portions thereof, can embody a user computing device 108, in some embodiments. Additionally, or alternatively, some components of the computing system 1000 can embody the stand-in system 102 and/or transaction processing system 106. For example, one or more of the functional modules 118, 120, 122, 124, 126, 128 can be embodied as program modules 1030. For example, the allocation module 122 can be embodied as program modules 1030. In another example, the cache module 126 can be embodied as program modules 1030. Some components of the computing system 1000 can embody system 100, 300, 400, 900. For example, the data extractor 908 can be embodied as program modules 1030.

In some embodiments, a computer-implemented method includes: obtaining a service request at a domain level of a first computing device, the domain level including a plurality of services; determining one or more services of the plurality of services at the domain level to fulfill the service request; in response to determining at least one service of the one or more services is unavailable, providing a model as a stand-in service for the at least one service; determining, by the one or more services and the model, a decision based on the service request; and sending, in response to the service request, the decision as output by the domain level.

In some embodiments, the computer-implemented method further includes: obtaining a first dataset corresponding to an activity of the plurality of services from a data store; determining a dependency of the data in the first dataset to the plurality of services; and storing the first dataset including the determined dependency data in a cache as a second dataset, wherein the model utilizes data stored in the cache including the second dataset to enable the model to serve as the stand-in service for the at least one service.

In some embodiments, the first dataset obtained from the data store corresponds to the activity of the plurality of services since a last update.

In some embodiments, determining the dependency of the first dataset to the plurality of services includes: extracting one or more features corresponding to the activity of the plurality of services from the data store; aggregating the extracted one or more features to generate the first dataset; and associating each data subset of a plurality of data subsets of the first dataset to a respective service of the plurality of services, wherein each data subset of the plurality of data subsets includes one or more data points of the first dataset.

In some embodiments, the computer-implemented method further includes: allocating an identifier to each subset of the plurality of data subsets based on the determined data dependency; and storing the plurality of data subsets including corresponding identifiers in the cache, wherein the identifier corresponds to a key-value pair for retrieving a corresponding data subset of the plurality of data subsets from the cache by the model.

In some embodiments, providing the model as the stand-in service for the at least one service further includes: obtaining data for the at least one service based on a context of the service request; identifying one or more keys based on the obtained context data; retrieving, based on the one or more keys, a corresponding one or more data subsets from the cache; and applying the retrieved one or more data subsets to the model, wherein the decision is based on the one or more data subsets applied to the model.

In some embodiments, the computer-implemented method further includes: obtaining, by the first computing device, a user request from a second computing device; identifying one or more domain levels to fulfill the user request based on a context of the user request; and determining one or more service requests based on the user request and allocating the one or more service requests to a respective domain level of the one or more domain levels, wherein the one or more domain levels includes the domain level.

In some embodiments, the computer-implemented method further includes: training the model using a training dataset corresponding to an activity of the plurality of services, the training dataset being based on data obtained from a data store, wherein the trained model includes the model.

In some embodiments, the trained model is configured to serve as a stand-in for the plurality of services at the domain level.

In some embodiments, a system includes: a processor; and a non-transitory computer readable media having stored thereon instructions executable by the processor to perform operations including: obtain a service request at a domain level, the domain level including a plurality of services; determine one or more services of the plurality of services at the domain level to fulfill the service request; obtain a first dataset corresponding to an activity of the plurality of services from a data store; determine a dependency of the data in the first dataset to the plurality of services; store the first dataset including the determined dependency data in a cache as a second dataset; in response to determining at least one service of the one or more services is unavailable, provide a model as a stand-in service for the at least one service; determine, by the one or more services and the model, a decision based on the service request and the second dataset; and send, in response to the service request, the decision as output by the domain level, wherein the model utilizes data stored in the cache including the second dataset to enable the model to serve as the stand-in service for the at least one service.

In some embodiments, in the system, the operations further includes: obtain a user request from a user computing device; identify one or more domain levels to fulfill the user request based on the user request; and determine one or more service requests based on the user request and allocate each service requests of the one or more service requests to a respective domain level of the one or more domain levels, wherein the one or more domain levels includes the domain level.

In some embodiments, in the system, determining the data dependency of the first dataset to the plurality of services includes: extract one or more features corresponding to the activity of the plurality of services from the data store; aggregate the extracted one or more features to generate the first dataset; and associate each data subset of a plurality of data subsets of the first dataset to a respective service of the plurality of services, wherein the first dataset corresponds to the activity of the plurality of services since a last update, and wherein each data subset of the plurality of data subsets includes one or more data points of the first dataset.

In some embodiments, in the system, the operations further includes: allocate an identifier to each data subset of the plurality of data subsets based on the determined data dependency; and store the plurality of data subsets including corresponding identifiers in the cache, wherein the identifier corresponds to a key-value pair for retrieving a corresponding data subset of the plurality of data subsets from the cache by the model.

In some embodiments, in the system, the operations further includes: obtain data for the at least one service based on a context of the service request; identify one or more keys based on the obtained context data; retrieve, based on the one or more keys, a corresponding one or more data subsets from the cache; and apply the retrieved one or more data subsets to the model; wherein the decision is based on the one or more data subsets applied to the model.

In some embodiments, in the system, the operations further includes: train the model using a training dataset corresponding to the activity of the plurality of services from the data store, the training dataset being based on data obtained from the data store; wherein the trained model includes the model.

In some embodiments, in the system, the trained model is configured to serve as a stand-in for the plurality of services at the domain level.

In some embodiments, a non-transitory computer readable media having stored thereon instructions executable by a processor of a computing device to cause the computing device to perform operations including: train a model using a training dataset corresponding to an activity of a plurality of services at a domain level; obtain a service request at the domain level, the domain level including the plurality of services; determine one or more services of the plurality of services at the domain level to fulfill the service request; in response to determining at least one service of the one or more services is unavailable, provide the trained model as a stand-in service for the at least one service; determine, by the one or more services and the trained model, a decision based on the service request; and send, in response to the service request, the decision as output by the domain level.

In some embodiments, the non-transitory computer readable media includes instructions to cause the computing device to perform operations further including: store data corresponding to the activity of the plurality of services in a data store at the domain level; and obtain the data corresponding to the activity of the plurality of services from the data store to generate the training dataset, the obtained data from the data store corresponding to the activity of the plurality of services since a last update of the training dataset, wherein the trained model is configured to serve as a stand-in for the plurality of services at the domain level.

In some embodiments, the non-transitory computer readable media includes instructions to cause the computing device to perform operations further including: obtain a first dataset corresponding to the activity of the plurality of services from the data store; determine a data dependency of the first dataset to the plurality of services, wherein determining the data dependency of the first dataset to the plurality of services including: extract one or more features corresponding to the activity of the plurality of services from the data store; aggregate the extracted one or more features to generate the first dataset; and associate each data subset of a plurality of data subsets of the first dataset to a respective service of the plurality of services, wherein each data subset of the plurality of data subsets includes one or more data points of the first dataset; allocate an identifier of a plurality of identifiers to each respective subset of the plurality of data subsets based on the determined data dependency; and store the first dataset including the determined dependency data and the plurality of identifiers as a second dataset in a cache, the identifier corresponding to a key-value pair for retrieving the corresponding data subset of the plurality of data subsets from the cache by the model, wherein the first dataset corresponds to the activity of the plurality of services since the last update, and wherein the model utilizes data stored in the cache including the second dataset to enable the model to serve as the stand-in service for the at least one service.

In some embodiments, the non-transitory computer readable media includes instructions to cause the computing device to perform operations further including: obtain, by the trained model, data corresponding to a context of the service request for the at least one service; identify, by the trained model, one or more keys based on the obtained context data; retrieve, by the trained model based on the one or more keys, a corresponding one or more data subsets from the cache; and apply the one or more data subsets to the trained model, wherein the decision is based on the one or more data subsets applied to the trained model.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

1. A computer-implemented method comprising:
obtaining a service request at a domain level of a first computing device, the domain level including a plurality of services;
determining one or more services of the plurality of services at the domain level to fulfill the service request;
in response to determining at least one service of the one or more services is unavailable, providing a model as a stand-in service for the at least one service;
determining, by the one or more services and the model, a decision based on the service request; and
sending, in response to the service request, the decision as output by the domain level,
wherein the model is configured to serve as a stand-in service for at least two services of the plurality of services responsive to becoming unavailable.

2. The computer-implemented method of claim 1, further comprising:
obtaining a first dataset corresponding to an activity of the plurality of services from a data store;
determining a dependency of the data in the first dataset to the plurality of services; and
storing the first dataset including the determined dependency data in a cache as a second dataset,
wherein the model utilizes data stored in the cache including the second dataset as training data to train the model to serve as the stand-in service for the at least one service.

3. The computer-implemented method of claim 2, wherein the first dataset obtained from the data store corresponds to the activity of the plurality of services since a last update.

4. The computer-implemented method of claim 2, wherein determining the dependency of the first dataset to the plurality of services comprises:
extracting one or more features corresponding to the activity of the plurality of services from the data store;
aggregating the extracted one or more features to generate the first dataset; and
associating each data subset of a plurality of data subsets of the first dataset to a respective service of the plurality of services,
wherein each data subset of the plurality of data subsets includes one or more data points of the first dataset.

5. The computer-implemented method of claim 4, further comprising:
allocating an identifier to each subset of the plurality of data subsets based on the determined data dependency; and
storing the plurality of data subsets including corresponding identifiers in the cache,
wherein each identifier corresponds to a key-value pair for retrieving a corresponding data subset of the plurality of data subsets from the cache by the model based on the identifier matching a corresponding key of a given key set.

6. The computer-implemented method of claim 5, wherein providing the model as the stand-in service for the at least one service further comprises:
obtaining data for the at least one service based on a context of the service request;
generating one or more keys based on the context of the service request from the obtained data;
retrieving, based on the one or more keys, a corresponding one or more data subsets from the cache; and
applying the retrieved one or more data subsets as training data to train the model to serve as the stand-in service for the at least one service,
wherein the decision is based on the one or more data subsets applied to the model.

7. The computer-implemented method of claim 1, further comprising:
obtaining, by the first computing device, a user request from a second computing device;
identifying one or more domain levels to fulfill the user request based on a context of the user request; and
determining one or more service requests based on the user request and allocating the one or more service requests to a respective domain level of the one or more domain levels,
wherein the one or more domain levels comprise the domain level.

8. The computer-implemented method of claim 1, further comprising:
training the model using a training dataset corresponding to an activity of the plurality of services, the training dataset being based on data obtained from a data store,
wherein the trained model comprises the model.

9. The computer-implemented method of claim 8, wherein the trained model is configured to serve as a stand-in for the plurality of services at the domain level.

10. A system comprising:
a processor; and
a non-transitory computer readable media having stored thereon instructions executable by the processor to perform operations comprising:
obtain a service request at a domain level, the domain level including a plurality of services;
determine one or more services of the plurality of services at the domain level to fulfill the service request;
obtain a first dataset corresponding to an activity of the plurality of services from a data store;
determine a dependency of the data in the first dataset to the plurality of services;
store the first dataset including the determined dependency data in a cache as a second dataset;
in response to determining at least one service of the one or more services is unavailable, provide a model as a stand-in service for the at least one service;
determine, by the one or more services and the model, a decision based on the service request and the second dataset; and
send, in response to the service request, the decision as output by the domain level,
wherein the model utilizes data stored in the cache including the second dataset to enable the model to serve as the stand-in service for the at least one service,
wherein the model can be trained to serve as a stand-in service for at least two services of the plurality of services responsive to becoming unavailable.

11. The system according to claim 10, the operations further comprising:
obtain a user request from a user computing device;
identify one or more domain levels to fulfill the user request based on the user request; and
determine one or more service requests based on the user request and allocate each service requests of the one or more service requests to a respective domain level of the one or more domain levels,
wherein the one or more domain levels comprises the domain level.

12. The system according to claim 10, wherein determining the data dependency of the first dataset to the plurality of services comprises:
extract one or more features corresponding to the activity of the plurality of services from the data store;
aggregate the extracted one or more features to generate the first dataset; and
associate each data subset of a plurality of data subsets of the first dataset to a respective service of the plurality of services,
wherein the first dataset corresponds to the activity of the plurality of services since a last update, and wherein each data subset of the plurality of data subsets includes one or more data points of the first dataset.

13. The system according to claim 12, the operations further comprising:
allocate an identifier to each data subset of the plurality of data subsets based on the determined data dependency; and
store the plurality of data subsets including corresponding identifiers in the cache,
wherein the identifier corresponds to a key-value pair for retrieving a corresponding data subset of the plurality of data subsets from the cache by the model.

14. The system according to claim 13, the operations further comprising:
obtain data for the at least one service based on a context of the service request;
identify one or more keys based on the obtained context data;
retrieve, based on the one or more keys, a corresponding one or more data subsets from the cache; and
apply the retrieved one or more data subsets to the model;
wherein the decision is based on the one or more data subsets applied to the model.

15. The system according to claim 10, the operations further comprising:
train the model using a training dataset corresponding to the activity of the plurality of services from the data store, the training dataset being based on data obtained from the data store;
wherein the trained model comprises the model.

16. The system according to claim 15, wherein the trained model is configured to serve as a stand-in for the plurality of services at the domain level.

17. A non-transitory computer readable media having stored thereon instructions executable by a processor of a computing device to cause the computing device to perform operations comprising:
train a model using a training dataset corresponding to an activity of a plurality of services at a domain level;
obtain a service request at the domain level, the domain level including the plurality of services;
determine two or more services of the plurality of services at the domain level to fulfill the service request;
in response to determining at least one service of the two or more services is unavailable, provide the trained model as a stand-in service for the at least one service;
determine, by a remaining service of the two or more services and the trained model, a decision based on the service request; and
send, in response to the service request, the decision as output by the domain level,
wherein the model can serve as a stand-in service for the two or more services responsive to becoming unavailable.

18. The non-transitory computer readable media of claim 17, the operations further comprising:
store data corresponding to the activity of the plurality of services in a data store at the domain level; and
obtain the data corresponding to the activity of the plurality of services from the data store to generate the training dataset, the obtained data from the data store corresponding to the activity of the plurality of services since a last update of the training dataset,
wherein the trained model is configured to serve as a stand-in for the plurality of services at the domain level.

19. The non-transitory computer readable media of claim 18, the operations further comprising:
obtain a first dataset corresponding to the activity of the plurality of services from the data store;
determine a data dependency of the first dataset to the plurality of services, wherein determining the data dependency of the first dataset to the plurality of services comprising:
extract one or more features corresponding to the activity of the plurality of services from the data store;
aggregate the extracted one or more features to generate the first dataset; and
associate each data subset of a plurality of data subsets of the first dataset to a respective service of the plurality of services,
wherein each data subset of the plurality of data subsets includes one or more data points of the first dataset;
allocate an identifier of a plurality of identifiers to each respective subset of the plurality of data subsets based on the determined data dependency; and
store the first dataset including the determined dependency data and the plurality of identifiers as a second dataset in a cache, the identifier corresponding to a key-value pair for retrieving the corresponding data subset of the plurality of data subsets from the cache by the model,
wherein the first dataset corresponds to the activity of the plurality of services since the last update, and wherein the model utilizes data stored in the cache including the second dataset to enable the model to serve as the stand-in service for the at least one service.

20. The non-transitory computer readable media of claim 19, the operations further comprising:
obtain, by the trained model, data corresponding to a context of the service request for the at least one service;
identify, by the trained model, one or more keys based on the obtained context data;
retrieve, by the trained model based on the one or more keys, a corresponding one or more data subsets from the cache; and
apply the one or more data subsets to the trained model,
wherein the decision is based on the one or more data subsets applied to the trained model.
